(19) United States
(12) Patent Application Publication
(10) Pub. No.: US 2020/0373863 A1
(43) Pub. Date: Nov. 26, 2020

(54) SLOTLESS SYNCHRONOUS PERMANENT MAGNET MOTOR

(71) Applicant: ATLAS COPCO INDUSTRIAL TECHNIQUE AB, Stockholm (SE)

(72) Inventor: Jonas Gustav MILLINGER, Sköntorpsvägen (SE)

(73) Assignee: ATLAS COPCO INDUSTRIAL TECHNIQUE AB, Stockholm (SE)

(21) Appl. No.: 16/966,346

(22) PCT Filed: Jan. 29, 2019
(86) PCT No.: PCT/EP2019/052058

§ 371 Date: Jul. 30, 2020

(30) Foreign Application Priority Data
Jan. 31, 2018 (SE) 1830033-5

(51) Int. Cl. H02P 6/18; H02K 1/24; H02K 1/27; H02P 6/00; H02P 25/026; H02P 23/00

(52) U.S. Cl. CPC H02P 6/186; H02K 1/24; H02K 1/276; H02P 23/0004; H02P 6/007; H02P 25/026; H02P 6/183

(57) ABSTRACT

A slotless synchronous permanent magnet motor includes a rotor, and a stator configured to electromagnetically interact with the rotor. The rotor is provided with a first conductive metal layer configured to create harmonic rotor saliency.

### TECHNICAL FIELD

The present disclosure generally relates to synchronous motors. In particular, it relates to slotless synchronous permanent magnet motors.

### BACKGROUND

Slotless permanent magnet motors are usually preferred in applications with high power density requirements, such as in industrial assembly and percussive tools.

Applications of this type require advanced motor control, which is typically achieved by means of a power converter connected to the motor and operated by means of pulse width modulation (PWM).

For the applications identified above a commutation transducer, or angle encoder, for rotor position detection feedback inside the speed control loop of the drive circuit is often utilised. A drawback of using a transducer is an increased complexity and size of the motor module.

The paper “Sensorless Estimation of Rotor Position of Cylindrical Brushless DC Motors Using Eddy Currents” by Tomita et al, Proceedings of 4th IEEE International Workshop on Advanced Motion Control—AMC '96—MIE, March 1996, Vol. 1, pp. 24-28 discloses a motor structure with a slotted stator core. Non-magnetic material is pasted on the rotor surface to flow eddy currents.

### SUMMARY

A common method for sensorless rotor position detection of slotted machines involves the use of a salient pole rotor design. The rotor position can be detected by signal processing of the harmonic phase currents. In contrast to their slotted counterparts, salient rotor design of slotless motors requires removal of active permanent-magnet material, resulting in reduced motor performance.

In view of the above, an object of the present disclosure is to provide a slotless synchronous permanent magnet motor which solves or at least mitigates the above-indicated problems.

There is hence according to a first aspect of the present disclosure provided a slotless synchronous permanent magnet, PM, motor comprising: a rotor, and a stator configured to electromagnetically interact with the rotor, wherein the rotor is provided with a first conductive metal layer configured to create harmonic rotor saliency.

Electrically conductive materials such as copper and aluminium behave like air from a magnetic perspective at low frequencies, but reflect high frequency magnetic flux according to Lenz's law. The reflection becomes significant for skin depths δ smaller than the thickness of the conductive layer h. Due to the rotor being provided with the first metal layer, high frequency saliency of the rotor may be obtained. Hence, by means of the present design, rotor position detection may be achieved based on salient rotor behaviour for high switching frequencies of the switches of a power converter configured to control the slotless synchronous PM motor. In particular, rotor position detection with minimal impact on motor performance may be provided.

Furthermore, since no sensor is required to determine the rotor position, the slotless synchronous PM motor may be made shorter, cheaper and more reliable.

In relation to the slotted configuration disclosed in the paper by Tomita et al, a configuration with a first conductive layer provided on the rotor of a slotless synchronous PM motor is surprisingly much more precise with regards to rotor position determination. According to the paper by Tomita, the rotor position estimation has a maximum error of 26°, which is not useful for many control schemes, whereas in the case of a slotless synchronous PM motors, the precision may be below ±5°, down to ±2°. Additionally, for slotted motors, the rotor position estimation is dependent of the motor load, whereas it is independent of the motor load for slotless synchronous PM motors. Hence, the proposed slotless synchronous PM motor configuration is much more useful for rotor position determination. For example, motor control involving sinusoidal commutation may be used instead of six step commutation as would have to be the case in Tomita, whereby torque ripple can be eliminated and smooth motion and precise motor control can be provided.

With “rotor position” is generally meant the electric rotor position. The rotor position may for example be a rotor angle between a stationary frame such as the αβ-frame and a rotor reference frame such as the d-q frame. With harmonic rotor saliency is meant rotor saliency for harmonics with respect to the fundamental frequency. The fundamental frequency is the number of rotor revolutions per second.

The first metal layer may be a first metal sheet or a first metal coating layer.

The external surface of the first metal layer may be flush or essentially flush with the outer surface of the rotor.

The first metal layer may be made of a weakly magnetic material such as a paramagnetic or a diamagnetic material.

According to one embodiment the first metal layer is made of copper or aluminium. The first metal layer may for example consist of copper or aluminium. The first metal layer could alternatively be made of a conductive alloy.

The stator may be provided with a plurality of windings, i.e. stator phase windings, each winding being configured to be connected to a respective electrical phase. In particular, each winding has two winding portions. The winding portions of a winding are connected to a respective terminal of the power converter. The terminals connected to a winding are associated with the same electrical phase.

In examples in which the first metal layer is the only metal layer to provide harmonic rotor saliency, the first metal layer may be configured to align with both winding portions of a winding of an electrical phase simultaneously at any rotational position of the rotor. According to one embodiment the rotor is provided with a second conductive metal layer configured to create harmonic rotor saliency.

The second metal layer may be a second metal sheet or a second metal coating layer.

The external surface second metal layer may be flush or essentially flush with the outer surface of the rotor.

The second metal layer may be made of a weakly magnetic material such as a paramagnetic or a diamagnetic material.

The second metal layer may be made of copper or aluminium. The second metal layer may for example consist of copper or aluminium. The second metal layer could alternatively be made of a conductive alloy.

In examples comprising a first metal layer and a second metal layer, the first metal layer and the second metal layer may be configured so that the first metal layer and the second metal layer simultaneously can align with a respective winding portion of an electrical phase.

According to one embodiment the first conductive metal layer and the second metal layer are electrically connected. The first conductive metal layer and the second conductive metal layer may for example be connected to each other at each end portion or end of the rotor in the axial direction. The first conductive metal layer and the second conductive metal layer may hence be connected and short-circuited in two locations, one at each end portion or end of the rotor. The current induced in the first conductive metal layer and the second conductive metal layer will thereby flow in opposite directions with respect to each other, and the current will hence obtain a return path. The levels of induced current will thereby increase when subjected to d-axis oriented current and hence higher rotor saliency will be obtained. Hence a stronger saliency indication with higher signal to noise ratio may be obtained. The estimation of the rotor position may thereby be made more precise.

According to one embodiment in cross-section of the rotor the first metal layer is provided peripherally on the rotor, forming the arc of a first circle sector.

In an embodiment which only comprises the first metal layer the central angle of the first circle sector may be at least 120 degrees, for example 120 degrees. This configuration is advantageously used in a slotless synchronous PM motor of concentrated windings type. In this case, the first metal layer may beneficially be arranged in a skewed manner in the axial direction of the rotor. This improves detectability of inductance changes in the electrical phases caused by the harmonic rotor saliency.

According to one embodiment in cross-section of the rotor the second metal layer is provided peripherally on the rotor, forming the arc of a second circle sector, the centre of the arc of the second circle sector being at an angle with respect to the centre of the arc of the first circle sector.

According to one embodiment the angle is about 180°. With about 180° angle is meant a range of 180°±20°, for example a range of 180°±10°. The angle could alternatively be 180°.

According to one embodiment the first metal layer is arranged between magnet segments of the rotor to form a first central plane of the rotor, and the second metal layer is arranged between magnet segments of the rotor to form a second central plane of the rotor, perpendicular to the first central plane.

According to one embodiment the first metal layer extends along a majority of the axial length of the rotor. The first metal layer may in particular form a contiguous structure from one short end thereof to the opposite short end.

The second metal layer may extend along a majority of the axial length of the rotor. The second metal layer may in particular form a contiguous structure from one short end thereof to the opposite short end.

There is according to a second aspect of the present disclosure provided a slotless synchronous PM motor system comprising: a slotless synchronous PM motor according to the first aspect, a power converter configured to inject a current or voltage into the slotless synchronous PM motor, current sensors configured to measure a current in the slotless synchronous PM motor generated due to the current or voltage injected by the power converter, and a control system configured to determine a rotor position based on the current measured by the current sensors.

Each current sensor may be configured to measure current in a respective electrical phase. The current sensors may in particular be configured to measure the current in a respective winding of the stator. The number of currents measured may thus typically be the same as the number of electrical phases of the slotless synchronous PM motor.

The current measured by the current sensors may in some embodiments be a current ripple. In this case, the control system is configured to determine the rotor position based on the current ripple.

The current ripple may be commutation-induced current ripple. Commutation occurs when the polarity changes in an electrical phase.

The power converter may comprise wide bandgap semiconductor switches, for example wide bandgap transistors.

According to one embodiment the power converter is configured to inject current to the slotless synchronous PM motor using a switching frequency of switches of the power converter sufficiently high for the skin depth δ in the first metal layer to be less than the thickness h of the first metal layer, the skin depth being defined by

$$δ = \sqrt{\frac{2 ρ}{μ π f}}$$

where ρ is the resistivity of the first metal layer, μ is the permeability of the first metal layer, and f is the switching frequency.

When the rotor is provided with more than one metal layer, the above considerations concerning skin depth and thickness apply to all of the metal layers, e.g. also to a second metal layer.

The slotless synchronous PM motor system may utilise a high switching frequency, enabling the use of thin first/second metal layer(s), thus resulting in minimal impairment on motor performance.

The switching frequency may for example be in the order of 100 kHz.

According to one embodiment the injected voltage may comprise a high frequency voltage component such as a high frequency sinusoidal voltage component. The high frequency component may be specifically injected for the purpose of rotor position determination. The high frequency component may have an angular frequency that is higher than the maximum angular frequency of the slotless synchronous PM motor.

According to one embodiment the control system is configured to determine an inductance for each electric phase based on a current ripple of the measured current, and wherein the control system is configured to determine the rotor position based on the inductances.

The inductance for each phase may for example be determined by the inclination or derivative

$$\frac{dI}{dt}$$

of the current ripple between commutations, from which the inductance L for an electrical phase may be obtained by

$$L = U / \frac{dI}{dt} ,$$

where U is the phase voltage.

According to one embodiment the rotor position is determined by comparing the inductances with reference inductances associated with specific rotor positions in a look-up table. In particular, the combination of the inductances, and in particular the matching reference inductances, provide a single rotor position value in the look-up table.

According to one embodiment the current sensors are configured to oversample a current ripple of the measured current. Oversampling is to be construed as a sampling frequency which is higher than the Nyquist frequency.

According to one embodiment the stator has a plurality of stator phase windings, and wherein the control system is configured to compensate for a geometric asymmetry of the stator phase windings.

The geometric asymmetry of the stator phase windings, i.e. displacement of one or more of the stator phase windings in the circumferential direction of the stator such that symmetry along a radial plane is non-perfect due to non-ideal manufacturing has proved to influence the estimation of the rotor position according to research conducted by the present inventor. In particular, the estimation error is increased by geometric asymmetry. By compensating for the geometric asymmetry, the estimation/determination of the rotor position may be made more precise.

According to one embodiment the control system comprises a first transformation block configured to perform the compensation by utilising a transformation of voltage references for the power converter from a rotor reference frame to a three-phase frame, the transformation taking displacement of the stator phase windings in the circumferential direction of the stator, defining the geometric asymmetry, into account.

In particular, the angular displacement of each stator phase winding may be used in the transformation to provide the compensation. The transformation may for example be a linear operator such as a matrix, for transforming between the rotor reference frame and the abc-frame, or the stator reference frame and the abc-frame.

According to one embodiment the control system includes a second transformation block configured to transform the current measured by the current sensors to obtain a d-axis current and a q-axis current, a demodulator block configured to demodulate the q-axis current, and an estimator block including a PI-observer, configured to use feed-forward of the demodulated q-axis current, for determining the rotor position.

Transient behaviour will thereby be improved. In particular, in the event of a transient, steady state with very low estimation error can quickly be obtained.

There is according to a third aspect of the present disclosure provided a method of determining a rotor position of rotor of a slotless synchronous PM motor according to the first aspect, wherein the method comprises: controlling a power converter to inject a current or a voltage into the slotless synchronous PM motor, obtaining current measured in the slotless synchronous PM motor generated due to the injected current, and determining a rotor position based on the current.

According to one embodiment the controlling involves using a switching frequency of switches of the power converter sufficiently high for the skin depth δ in the first metal layer to be less than the thickness h of the first metal layer, the skin depth being defined by

$$δ = \sqrt{\frac{2 ρ}{μ π f}}$$

where ρ is the resistivity of the first metal layer, μ is the permeability of the first metal layer, and f is the switching frequency.

According to one embodiment the stator has a plurality of stator phase windings, and wherein step a) involves compensating for a geometric asymmetry of the stator phase windings.

According to one embodiment the compensating involves utilising a transformation of voltage references for the power converter from a rotor reference frame to a three-phase frame, the transformation taking displacement of the stator phase windings in the circumferential direction of the stator, defining the geometric asymmetry, into account.

According to one embodiment the determining involves transforming the measured current to obtain a d-axis current and a q-axis current, demodulating the q-axis current, and utilising an estimator block including a PI-observer, using feed-forward of the demodulated q-axis current.

There is according to a fourth aspect of the present disclosure provided a computer program comprising computer code which when executed by processing circuitry of a slotless synchronous PM motor system causes the slotless synchronous PM motor system to perform the steps of the method according to the third aspect.

There is according to a fifth aspect of the present disclosure provided a power tool comprising a slotless synchronous PM motor according to the first aspect.

There is according to a sixth aspect of the present disclosure provided a power tool comprising a slotless synchronous PM motor system according to the second aspect.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc.”, unless explicitly stated otherwise.

### BRIEF DESCRIPTION OF THE DRAWINGS

The specific embodiments of the inventive concept will now be described, by way of example, with reference to the accompanying drawings, in which:

FIG. 1a schematically shows a cross-section of an example of a slotless synchronous PM motor;

FIG. 1b schematically shows a cross-section of the rotor of the slotless synchronous PM motor in FIG. 1a;

FIG. 2 schematically shows a cross-section of another example of a slotless synchronous PM motor;

FIG. 3 schematically shows a cross-section of yet another example of a slotless synchronous PM motor;

FIG. 4 schematically shows a block diagram of a slotless synchronous PM motor system;

FIG. 5 is a flowchart of a method of determining the rotor position of a rotor of a slotless synchronous PM motor; and

FIG. 6 schematically depicts an example of an alternative control scheme for controlling the slotless synchronous PM.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

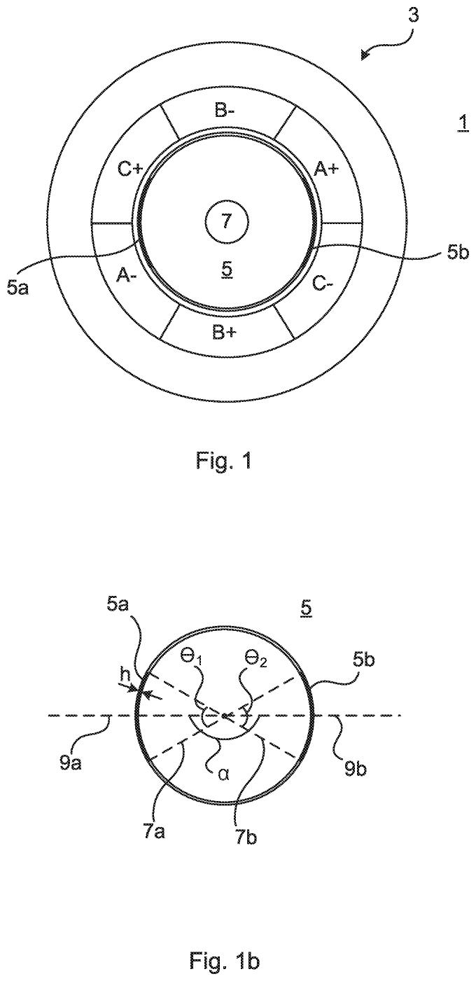

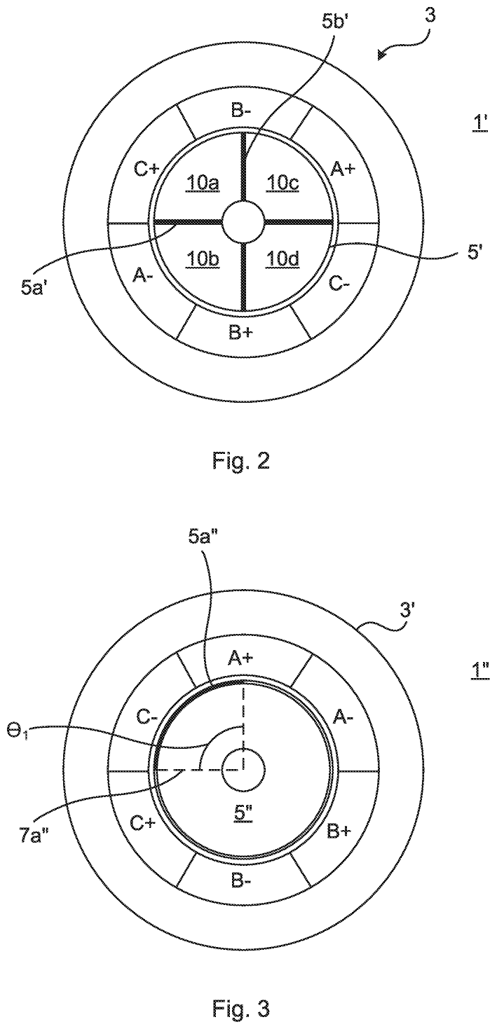

FIG. 1 shows an example of a slotless synchronous PM motor. The slotless synchronous PM motor 1 includes a stator 3 and a rotor 5 configured to electromagnetically interact with the stator 3. The rotor 5 is a permanent magnet rotor. The stator 3 has a plurality of windings i.e. stator phase windings, each being connected to a respective electrical phase A, B and C. In the present example, the windings are connected such that winding portions of the same electric phase are arranged opposite to each other in a cross-section of the slotless synchronous PM motor 1. Thus, the two winding portions of electrical phase A, denoted by A+ and A− are arranged opposite to each other, the two winding portions of electrical phase B, denoted by B+ and B− are arranged opposite to each other, and the two winding portion of electrical phase C, denoted by C+ and C−, are arranged opposite to each other.

In case of a geometric asymmetry of the stator phase windings, the winding portions will not be exactly opposite to each other. There may in particular be a small displacement in the circumferential direction of the stator 3 between opposing winding parts of an electrical phase. This may lead to an error in the estimation/determination of the rotor position. According to some examples, compensation may be provided with regards to this geometric asymmetry, as will be described further below.

The slotless synchronous PM motor 1 comprises a rotor shaft 7 and the rotor 5 is arranged around the rotor shaft 6. The rotor 5 is rotatably arranged in the stator 3.

The rotor 5 has an electrically conductive first metal layer 5a and an electrically conductive second metal layer 5b. The first metal layer 5a and the second metal layer 5b create harmonic rotor saliency, as will be explained in the following. The first metal layer 5a forms part of the external surface of the rotor 5. The second metal layer 5b forms part of the external surface of the rotor 5. The first metal layer 5a extends along a majority of the axial length of the rotor 5. The first metal layer 5a is non-segmented, i.e. it is a single-piece contiguous structure. The second metal layer 5b extends along a majority of the axial length of the rotor 5. The second metal layer 5b is non-segmented, i.e. it is a single-piece contiguous structure. In general, the first metal layer 5a and the second metal layer 5b may be identical or essentially identical to each other.

The first metal layer 5a may be a first metal sheet or coating. The second metal layer 5b may be a second metal sheet or coating.

The first metal layer 5a and the second metal layer 5b may according to one variation be electrically connected to each other. The first metal layer 5a and the second metal layer 5b may be short-circuited. Hereto, the first metal layer 5a and the second metal layer 5b may be electrically connected to each other by means of one or more low-resistive connection(s). Typically, the first metal layer 5a and the second metal layer 5b are connected to each other at each end or end region/portion in the axial direction of the rotor 5. The one or more low-resistive connections may for example be made of the same material as the first metal layer 5a and/or the second metal layer 5b.

FIG. 1b depicts the rotor 5 in more detail. The first metal layer 5a extends in the circumferential direction peripherally along the rotor 5. The first metal layer 5a has a thickness h. The first metal layer 5a forms an arc of a first circle sector 7a of the rotor 5, having a first central angle θ1. The second metal layer 5b extends in the circumferential direction peripherally along the rotor 5. The second metal layer 5b forms an arc of a second circle sector 7b of the rotor 5, having a second central angle θ2. The first circle sector 7a and the second circle sector 7b are mutually disjoint. The first metal layer 5a and the second metal layer 5b are hence arranged along disjoint portions of the periphery of the rotor 5. For example, the centre 9a of the arc of the first circle sector 7a and the centre 9b of the second circle sector 7b may be at an angle α of about 180 degrees. The first metal layer 5a and the second metal layer 5b may hence be arranged oppositely in cross-section of the rotor 5.

The first central angle θ1 and the second central angle θ2 may typically be determined by the winding configuration of the slotless synchronous PM motor 1. For instance, for a two-pole configuration the first central angle θ1 and the second central angle θ2 may each be determined to be essentially equal to, equal to or larger than 2π/(the number of electrical phases times two), with the number of metal layers being equal to the number of poles. In the example in FIG. 1a, this would mean that the first central angle θ1 and the second central angle θ2 would each be equal to or greater than 60°, i.e. 360°/6.

FIG. 2 shows another example of a slotless synchronous PM motor. Slotless synchronous PM motor 1′ is similar to the example described with reference to FIGS. 1a and 1b. The rotor 5′ however differs somewhat from the rotor 5. Rotor 5′ has a first metal layer 5a′ and a second metal layer 5b′, which provide harmonic rotor saliency. The first metal layer 5a′ is provided between magnet segments 10a-10d and forms a first central plane extending through the rotor 5′, dividing the rotor 5′ into two halves in cross-section of the rotor 5′. The first metal layer 5a′ hence extends radially through the rotor 5′. The second metal layer 5b′ is provided between magnet segments 10a-10d and forms a second central plane extending through the rotor 5′a, dividing the rotor 5′ into two halves in cross-section of the rotor 5′. The second metal layer 5b′ extends radially through the rotor 5′. The first central plane and the second central plane are at an angle relative to each other. In the present example, the first central plane and the second central plane are perpendicular to each other.

Also in this case, according to one variation the first metal layer 5a′ and the second metal layer 5b′ may be electrically connected. The first metal layer 5a′ and the second metal layer 5b′ may be short-circuited. Hereto, the first metal layer 5a′ and the second metal layer 5b′ may be electrically connected to each other by means of one or more low-resistive connection(s). Typically, the first metal layer 5a′ and the second metal layer 5b′ are connected to each other at each end or end region/portion in the axial direction of the rotor 5. The one or more low-resistive connections may for example be made of the same material as the first metal layer 5a′ and/or the second metal layer 5b′.

FIG. 3 shows another example of a slotless synchronous PM motor. The slotless synchronous PM motor 1″ is of a concentrated winding type. The winding portions connected to the same electrical phase are hence arranged adjacent to each other, as illustrated in the drawing. For example, the two winding portions of phase A, indicated by A+ and A−, are located adjacent to each other and so on.

Also in this case a geometric asymmetry of the stator phase windings may be present. According to some examples, compensation may be provided with regards to this geometric asymmetry, as will be described further below.

The slotless synchronous PM motor 1″ comprises a rotor 5″ provided with a first metal layer 5a″. In particular, the exemplified rotor 5″ is provided with only a single metal layer, i.e. the first metal layer 5a″. The first metal layer 5a″ is provided peripherally on the rotor 5″. The first metal layer 5a″ forms the arc of a first circle sector 7a″ having a central angle θ1. The central angle θ1 may beneficially be essentially equal to, equal to or greater than 2n divided by the number of electrical phases. The number of metal layers is equal to the number of pole pairs. Thus, in this example, the central angle θ1 may be at least 120°, i.e. 360°/3, for example 120°. The first metal layer 5″ can thus be fully aligned with the two winding portions of a winding.

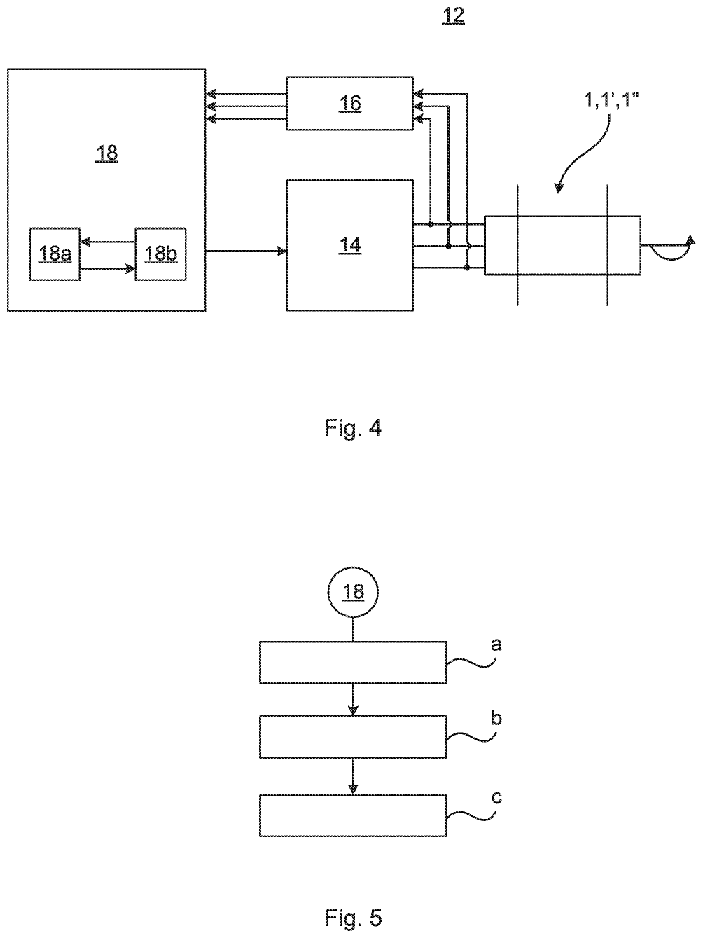

FIG. 4 depicts an example of a slotless synchronous PM motor system 12. The slotless synchronous PM motor system 12 comprises a slotless synchronous PM motor 1, 1′, 1″, a power converter 14, current sensors 16, and a control system 18.

The power converter 14 is configured to be connected to the windings of the stator 3, 3′. The power converter 14 comprises a plurality of switches or switching devices configured to be controlled to switch with a switching frequency to thereby inject suitable currents into the windings for operating the slotless synchronous PM motor 1, 1′, 1″. The switches may typically be power electronic switches such as semiconductor switches, e.g. transistors. The switches may for example be wide bandgap power electronic devices, such as silicon carbide or gallium nitride power electronic switches. The switches may be configured in a plurality of different known manners, for example in an H-bridge or half-bridge configuration, or a variation thereof.

The switches of the power converter 14 may for example be controlled by means of PWM. To this end, e.g. the gates of the switches may be controlled to selectively set the switches in an open or closed state based on a control signal that utilises PWM.

The power converter 14 and the current sensors 16 form a driver circuit for the slotless synchronous PM motor 1, 1′, 1″.

The current sensors 16 are configured to measure currents of the windings of the stator 3, 3′. The current sensors 16 may be configured to measure current, for example current ripple, in a respective electrical phase, i.e. in a respective winding. The current sensors 16 may beneficially have a high bandwidth to enable oversampling of the currents. The bandwidth of the current sensors 16 may preferably be more than twice that of the switching frequency of the switches of the power converter 14. The bandwidth may for example be more than three times, more than four times, more than five times, or more than six times that of the switching frequency.

The control system 18 may be configured to determine the rotor position of the rotor 5, 5′, 5″ based on the ripple currents measured by the current sensors 16. The control system 18 may comprise a storage medium 18 and processing circuitry 18b. The storage medium 18 comprises computer code or instructions which when executed by the processing circuitry 18b causes the control system 18 to perform the steps of the method as disclosed herein.

The processing circuitry 18b may for example use any combination of one or more of a suitable central processing unit (CPU), multiprocessor, microcontroller, digital signal processor (DSP), application specific integrated circuit (ASIC), field programmable gate arrays (FPGA) etc., capable of executing any herein disclosed operations concerning electrical rotor position determination.

The storage medium 18a may for example be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory.

The control system 18 may comprise a controller, which based on the determined rotor position is configured to control the power converter 14. With reference to FIG. 5, the operation of the control system 12 with regards to rotor position determination in the example described in FIG. 4 will now be described in more detail.

In a step a) the controller controls the power converter 14 to inject currents into the windings of the stator. This current control may typically involve switching the switches using PWM as previously mentioned.

Preferably, the switching frequency for controlling the switches of the power converter 14 is sufficiently high for the skin depth δ in the first metal layer 5a, 5a′, 5a″ and in embodiments comprising the second metal layer 5b, 5′b, to be less than the thickness h of the first metal layer 5a, 5a′, 5a″/second metal layer 5b, 5′b. This ensures that the high frequency flux pattern generated by the current ripple is blocked by the first metal layer 5a, 5a′, 5a/second metal layer 5b, 5′b as the rotor 5, 5′, 5″ rotates, thus affecting the inductance of the electrical phases. In particular, the high frequency flux pattern is blocked as the first metal layer 5a, 5a′, 5a″/second metal layer 5b, 5′b align(s) with energised winding portions of an electrical phase, causing a sinusoidal or quasi-sinusoidal change in the inductances of the electrical phases in question as the rotor 5, 5′, 5″ rotates. Specifically, the inductance of an electrical phase decreases as the first metal layer 5a, 5a′, 5a″/second metal layer 5b, 5′b align(s) with energised winding portions of that electrical phase, i.e. when the high frequency flux pattern is blocked, and increases otherwise. This results in a harmonic rotor saliency enabling rotor position detection without using an angle encoder.

In a step b) the current sensors 16 measure current ripple in the windings of the stator. The current ripple measured in each electrical phase is typically a commutation-induced current ripple, which can be derived from the switching of the switches of the power converter 14. The measured current ripple is obtained by the control system 18.

The inclination or derivative

$$\frac{dI}{dt}$$

of the current ripple between commutations may be determined based on the current ripple measurements. The phase voltage U of each electrical phase may also be measured.

In a step c) the rotor position is determined based on the current ripple by the control system 18. According to the present example, based on the derivative

$$\frac{dI}{dt}$$

of the current ripple for each phase, an inductance L for each phase may be determined by dividing the phase voltage U with the derivative

$$L = U / \frac{dI}{dt} .$$

of the current ripple, i.e. the inductance

$$\frac{dI}{dt}$$

When the inductance L for each electrical phase has been determined, each inductance L may be compared with reference inductances for the corresponding phase in a look-up table. The reference inductances are associated with specific rotor positions, i.e. the set of reference inductances matching the determined inductances provides the rotor position, typically a rotor angle.

The rotor angle can then be used for controlling the power converter by means of the control system 18. Thus, in a step following step c) the power converter may be controlled based on the rotor angle.

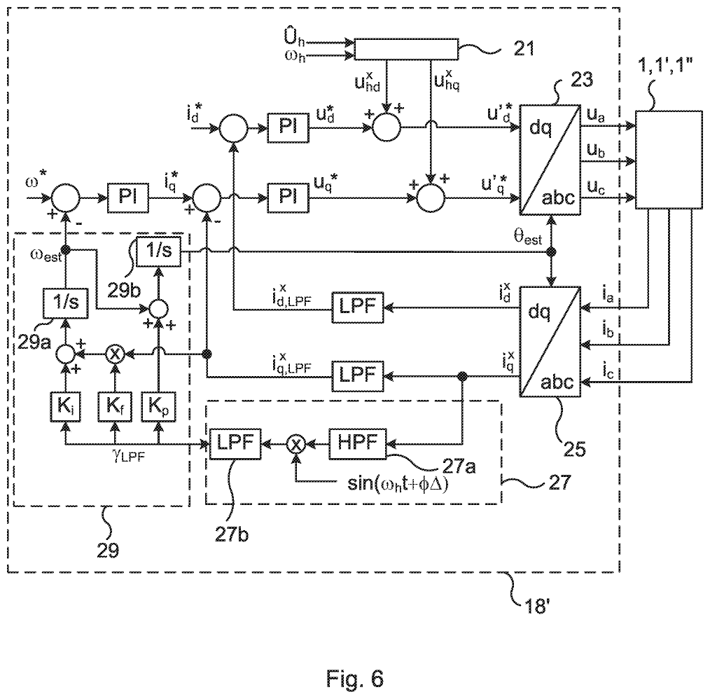

FIG. 6 depicts an example of an alternative control scheme for determining the rotor position. The control scheme shown in FIG. 5 may be implemented as software and/or hardware by the processing circuitry 18b. The power converter 14 and the current sensors 16 are not shows for reasons of simplicity.

The exemplified control system 18′ comprises a high frequency injection block 21 configured to inject a high frequency voltage component in the d-axis and in the q-axis of the rotor reference frame, or dq-frame. The high frequency voltage components are combined with the voltage references u_{d}′ and u_{q}* to form adjusted voltage references u_{d}′* and u_{q}′* for the power converter 14. The control system 18′ furthermore comprises a first transformation block 23 which is configured to transform the adjusted voltage references u_{d}′* and u_{q}′* from the rotor reference frame to the three-phase frame or abc-frame to obtain voltages uₐ, u_{b}, and u_{c}. The current sensors 16 are configured to measure the currents iₐ, i_{b} and i_{c} of the phases. The control system 18′ includes a second transformation block 25 configured to transform the measured currents iₐ, i_{b} and i_{c} to the rotor reference frame.

The exemplified control system 18′ furthermore comprises a demodulator block 27 configured to demodulate the measured q-axis current. The demodulator block 27 includes a high pass filter block 27a configured to high pass filter the q-axis current to obtain a high frequency component, with an angular frequency ωₕ being that of the injected high frequency voltage component utilised by the high frequency injection block 21, of the q-axis current. The high pass filtered q-axis current is then combined by multiplication with a sinusoidal signal with the frequency ωₕ. The demodulator block 27 may further comprise a low pass filter block 27b configured to low pass filter the combined signal to obtain a dc-signal.

The exemplified control system 18′ comprises an estimator block 29 which includes a PI-observer. The dc-signal is input to the estimator block 29 for PI-processing. The PI-observer uses feed-forward of the dc-signal. Hereto, the estimator block comprises a feed-forward coefficient k_{f}, which is multiplied with the dc-signal in addition to the dc-signal being multiplied with an integrating coefficient k_{f} and a proportionality constant kₚ. The dc-signal which has been multiplied with the feed-forward coefficient k_{f} is combined with a low-pass filtered measured q-axis current. This combined signal is added to the dc-signal multiplied with the integrating coefficient kᵢ, which is integrated in a first integration block 29a of the estimator block 29 to obtain an estimated rotor speed ωₑₛₜ. The estimated rotor speed ωₑₛₜ is used to obtain a rotor speed error to obtain a q-axis current reference i_{q}*. Additionally, the estimated rotor speed ωₑₛₜ is combined with a multiplication of the dc-signal and the proportionality constant kₚ, which combination is integrated in a second integrator block 29b of the estimator block 29 to obtain the estimated rotor position θₑₛₜ. The estimated rotor position θₑₛₜ is provided to the first transformation block 23 and the second transformation block for controlling the transformations between the rotor reference frame and the abc-frame, and hence for controlling the power converter 14.

The method described with reference to FIG. 6 is hence similar to the method described with reference to FIG. 5, in general steps a)-c) but without measuring and utilising the current ripple and determining inductances, and instead injecting a high-frequency voltage component and measuring the phase currents and processing these in the exemplified control scheme.

In some examples, the geometric asymmetry of the stator phase windings may be compensated. The control system 18, 18′ may hence be configured to compensate for a geometric asymmetry of the stator phase windings. In particular, the control system 18, 18′ may comprise a first transformation block configured to perform rotor reference frame to abc-frame transformations. The first transformation block may be configured to perform the compensation by utilising a transformation of voltage references for the power converter 14 from the rotor reference frame to the three-phase or abc-frame. The same compensation may also be provided in a second transformation block configured to perform abc-frame to rotor reference frame transformations.

The transformation between the rotor reference frame and the abc-frame may be configured to take displacement of the stator phase windings in the circumferential direction of the stator or angular displacement, defining the geometric asymmetry, into account. The transformation between the different frames is typically performed by a rotation matrix. The rotation matrix, and in particular the arguments of the cosine and sine functions, may comprise respective components which are related to the angular displacement of the stator phase windings.

In all of the examples provided herein, the rotor is received by the stator. However, as an alternative to any of these examples the inverse configuration is also possible, where the rotor is arranged around the stator, a so-called outer rotor machine.

The inventive concept has mainly been described above with reference to a few examples. However, as is readily appreciated by a person skilled in the art, other embodiments than the ones disclosed above are equally possible within the scope of the inventive concept, as defined by the appended claims.

1-21. (canceled)

22. A slotless synchronous permanent (PM) magnet motor comprising:
a rotor; and
a stator configured to electromagnetically interact with the rotor;
wherein:
the rotor is provided with a first conductive metal layer configured to create harmonic rotor saliency,
in cross-section of the rotor, the first metal layer is provided peripherally on the rotor, forming an arc of a first circle sector,
the rotor is further provided with a second conductive metal layer configured to create harmonic rotor saliency,
in cross-section of the rotor, the second metal layer is provided peripherally on the rotor, forming an arc of a second circle sector,
a center of the arc of the second circle sector is at an angle with respect to a center of the arc of the first circle sector, and
the first metal layer and the second metal layer are connected to each other at each end portion or end of the rotor in an axial direction, whereby an inductance of an electrical phase decreases as the first metal layer and second metal layer align with energised winding portions of that electrical phase, resulting in a harmonic rotor saliency enabling rotor position detection without using an angle encoder.

23. The slotless synchronous PM motor as claimed in claim 22, wherein the first metal layer is made of copper or aluminium.

24. The slotless synchronous PM motor as claimed in claim 22, wherein the angle is about 180°.

25. The slotless synchronous PM motor as claimed in claim 22, wherein the first metal layer is arranged between magnet segments of the rotor to form a first central plane of the rotor, and the second metal layer is arranged between magnet segments of the rotor to form a second central plane of the rotor, perpendicular to the first central plane.

26. The slotless synchronous PM motor as claimed in claim 22, wherein first metal layer extends along a majority of an axial length of the rotor.

27. A slotless synchronous PM motor system comprising:
the slotless synchronous PM motor as claimed in claim 22;
a power converter configured to inject a current or voltage into the synchronous PM motor;
current sensors configured to measure a current in the synchronous PM motor generated due to the current or voltage injected by the power converter; and
a control system configured to determine the rotor position based on the current measured by the current sensors.

28. The slotless synchronous PM motor system as claimed in claim 27, wherein the power converter is configured to inject current to the synchronous PM motor using a switching frequency of switches of the power converter sufficiently high for a skin depth δ in the first metal layer to be less than a thickness h of the first metal layer, the skin depth δ being defined by
$$δ = \sqrt{\frac{2 ρ}{μ π f}}$$
where ρ is a resistivity of the first metal layer, μ is a permeability of the first metal layer, and f is the switching frequency.

29. The slotless synchronous PM motor system as claimed in claim 27, wherein the control system is configured to determine an inductance for each electric phase based on a current ripple of the measured current, and wherein the control system is configured to determine the rotor position based on the inductances.

30. The slotless synchronous PM motor system as claimed in claim 29, wherein the rotor position is determined by comparing the inductances with reference inductances associated with specific rotor positions in a look-up table.

31. The slotless synchronous PM motor system as claimed in claim 27, wherein the current sensors are configured to oversample a current ripple of the measured current.

32. The slotless synchronous PM motor system as claimed in claim 27, wherein the stator has a plurality of stator phase windings, and wherein the control system is configured to compensate for a geometric asymmetry of the stator phase windings.

33. The slotless synchronous PM motor system as claimed in 32, wherein the control system comprises a first transformation block configured to perform the compensation by utilising a transformation of voltage references for the power converter from a rotor reference frame to a three-phase frame, the transformation taking displacement of the stator phase windings in a circumferential direction of the stator, defining the geometric asymmetry, into account.

34. The slotless synchronous PM motor system as claimed in claim 33, wherein the control system includes a second transformation block configured to transform the current measured by the current sensors to obtain a d-axis current and a q-axis current, a demodulator block configured to demodulate the q-axis current, and an estimator block including a PI-observer, configured to use feed-forward of the demodulated q-axis current, for determining the rotor position.

35. A method of determining the rotor position of the rotor of the slotless synchronous PM motor as claimed in claim 22, wherein the method comprises:
controlling a power converter to inject a current or voltage into the slotless synchronous PM motor;
obtaining current measured in the slotless synchronous PM motor generated due to the injected current or voltage; and
determining the rotor position based on the current.

36. The method as claimed in claim 35, wherein the controlling comprises using a switching frequency of switches of the power converter sufficiently high for a skin depth δ in the first metal layer to be less than a thickness h of the first metal layer, the skin depth δ being defined by
$$δ = \sqrt{\frac{2 ρ}{μ π f}}$$
where ρ is a resistivity of the first metal layer, μ is a permeability of the first metal layer, and f is the switching frequency.

37. The method as claimed in claim 36, wherein the stator has a plurality of stator phase windings, and wherein the controlling comprises compensating for a geometric asymmetry of the stator phase windings.

38. The method as claimed in claim 37, wherein the compensating comprises utilising a transformation of voltage references for the power converter from a rotor reference frame to a three-phase frame, the transformation taking displacement of the stator phase windings in a circumferential direction of the stator, defining the geometric asymmetry, into account.

39. The method as claimed in claim 35, wherein the determining comprises transforming the measured current to obtain a d-axis current and a q-axis current, demodulating the q-axis current, and utilising an estimator block including a PI-observer, using feed-forward of the demodulated q-axis current.
